(19) United States
(12) Patent Application Publication
(10) Pub. No.: US 2024/0381042 A1
(43) Pub. Date: Nov. 14, 2024

(54) PIEZOELECTRIC ACTUATOR WITH SPRING CLAMPING

(71) Applicant: Cochlear Limited, Macquarie University, NSW (AU)

(72) Inventors: Henrik FYRLUND, Mölnlycke (SE); Tommy BERGS, Härryda (SE); Per HILLSTRÖM, Mölnlycke (SE)

(21) Appl. No.: 18/685,049

(22) PCT Filed: Sep. 15, 2022
(86) PCT No.: PCT/IB2022/058722

§ 371 Date: Feb. 20, 2024

Related U.S. Application Data
(60) Provisional application No. 63/249,288, filed on Sep. 17, 2021.

(51) Int. Cl. H04R 25/00; H04R 17/00

(52) U.S. Cl. CPC H04R 25/606; H04R 17/00; H04R 2225/67; H04R 2440/01

(57) ABSTRACT

An apparatus includes an actuator configured to generate vibrations. The actuator includes a substantially planar piezoelectric oscillator having a central portion substantially surrounding and in mechanical communication with a coupling portion and a peripheral portion spaced from the coupling portion. The piezoelectric oscillator is configured to undergo bending oscillations in response to received electric voltage signals. The actuator further includes at least one mass configured to move in response to the bending oscillations of the piezoelectric oscillator. The actuator further includes at least one coupler configured to allow expansion and contraction of the peripheral portion along a first direction substantially parallel to the piezoelectric oscillator and to inhibit movement of the peripheral portion relative to the at least one mass along a second direction substantially perpendicular to the piezoelectric oscillator.

### BACKGROUND

### Field

The present application relates generally to an implantable actuator for generating vibrations, and more specifically, to implantable auditory prostheses for generating auditory vibrations.

### Description of the Related Art

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In one aspect disclosed herein, an apparatus comprises an actuator configured to generate vibrations. The actuator comprises a coupling portion configured to be in operative communication with a fixture implanted on or within a recipient's body. The actuator further comprises a substantially planar piezoelectric oscillator having a central portion substantially surrounding and in mechanical communication with the coupling portion and a peripheral portion spaced from the coupling portion. The piezoelectric oscillator is configured to undergo bending oscillations in response to received electric voltage signals. The actuator further comprises at least one mass in mechanical communication with the peripheral portion. The at least one mass is configured to move in response to the bending oscillations of the piezoelectric oscillator. The actuator further comprises at least one coupler mechanically attached at least to the peripheral portion and the at least one mass. The at least one coupler is configured to allow expansion and contraction of the peripheral portion along a first direction substantially parallel to the piezoelectric oscillator and to inhibit movement of the peripheral portion relative to the at least one mass along a second direction substantially perpendicular to the piezoelectric oscillator.

In another aspect disclosed herein, a method comprises applying oscillating electric voltage signals to a planar piezoelectric element having a central portion in mechanical communication with a fixture implanted on or within a recipient's body and a peripheral portion affixed to at least one mass and spaced from the central portion. The piezoelectric element is responsive to the electric voltage signals by oscillating between a first configuration with at least a portion of the peripheral portion extending above at least a portion of the central portion and a second configuration with at least a portion of the peripheral portion extending below at least a portion of the central portion. The method further comprises imparting oscillatory motion to the at least one mass, said oscillatory motion substantially perpendicular to the planar piezoelectric element. The method further comprises radially expanding and contracting the peripheral portion while inhibiting movement of the peripheral portion relative to the at least one mass along a direction substantially perpendicular to the planar piezoelectric element.

In another aspect disclosed herein, an apparatus comprises a substantially circular and planar piezoelectric material configured to generate vibrational energy by changing shape in response to received time-varying electrical voltage signals. The piezoelectric material comprises a central portion affixed to a cylindrical element in operative communication with a fixture implanted on or within a recipient's body. The piezoelectric material further comprises a peripheral portion substantially surrounding the central portion. The apparatus further comprises at least one mass in mechanical communication with the peripheral portion. The at least one mass is configured to move relative to the cylindrical element in response to shape changes of the piezoelectric material. The apparatus further comprises at least one coupler mechanically affixed to the peripheral portion and to the at least one mass. The at least one coupler is configured to allow radial relative movements between the peripheral portion and the at least one mass, the radial relative movements substantially parallel to the peripheral portion. The at least one coupler is configured to inhibit non-radial relative movements between the peripheral portion and the at least one mass, the non-radial relative movements substantially perpendicular to the peripheral portion.

### BRIEF DESCRIPTION OF THE DRAWINGS

Implementations are described herein in conjunction with the accompanying drawings, in which:

FIG. 1A schematically illustrates a portion of an example transcutaneous bone conduction device implanted in a recipient in accordance with certain implementations described herein;

FIG. 1B schematically illustrate a portion of another example transcutaneous bone conduction device implanted in a recipient in accordance with certain implementations described herein;

FIG. 1C depicts a side view of a portion of an example percutaneous bone conduction device in accordance with certain implementations described herein;

FIGS. 2A-2B schematically illustrate a side cross-sectional view and a top cross-sectional view, respectively, of an example apparatus in accordance with certain implementations described herein;

FIGS. 3A-3B schematically illustrate a side cross-sectional view and a top cross-sectional view, respectively, of another example apparatus in accordance with certain implementations described herein;

FIGS. 4A-4B schematically illustrate two example shapes of the piezoelectric oscillator during the bending oscillations in accordance with certain implementations described herein;

FIG. 5A schematically illustrates a cross-sectional perspective view of an example actuator in accordance with certain implementations described herein;

FIG. 5B schematically illustrates a portion of the example actuator of FIG. 5A;

FIG. 5C schematically illustrates a perspective view of the example actuator of FIG. 5A;

FIG. 6 schematically illustrates modeling of a conventional vibrational frequency distribution and an example vibrational frequency distribution generated by an actuator in accordance with certain implementations described herein;

FIG. 7A schematically illustrates a cross-sectional perspective view of another example actuator in accordance with certain implementations described herein;

FIG. 7B schematically illustrates a portion of the example actuator of FIG. 7A;

FIG. 7C schematically illustrates a top view of another example actuator in accordance with certain implementations described herein;

FIG. 7D schematically illustrates a perspective view of an example resilient material compatible with the example actuator of FIGS. 7A-7C;

FIGS. 8A and 8B schematically illustrate cross-sectional views of two example actuators that are substantially cylindrically symmetric about the longitudinal axis of the coupling portion in accordance with certain implementations described herein;

FIGS. 9A-9I schematically illustrate cross-sectional views of portions of various example actuators in accordance with certain implementations described herein;

FIGS. 10A and 10B schematically illustrate exploded and assembled cross-sectional views, respectively, of an example piezoelectric oscillator and at least one coupler in accordance with certain implementations described herein;

FIG. 11 schematically illustrates a top view of an example actuator having the at least one coupler affixed to the piezoelectric oscillator in accordance with certain implementations described herein;

FIGS. 12A and 12B schematically illustrate cross-sectional views of two example actuators with at least one coupler in accordance with certain implementations described herein; and

FIG. 13 is a flow diagram of an example method in accordance with certain implementations described herein.

### DETAILED DESCRIPTION

Certain implementations described herein provide a piezoelectric actuator having a disk-shaped piezoelectric material that is mechanically coupled to a counterweight such that radial expansion and contraction of the piezoelectric material is not substantially constrained. The mechanical coupling can comprise at least one resilient element that is sufficiently flexible in the radial direction and sufficiently rigid in a direction perpendicular to the radial direction such that flexing of the piezoelectric material vibrates the counterweight. Examples of the resilient element include one or more intermediate media (e.g., silicone or a soft adhesive) confined within a boundary (e.g., between the counterweight and a spring-like cap on top of the piezoelectric material) and/or one or more springs. The at least one resilient element can be selected to reduce the resonance frequency and/or to reduce the q-value of a resonance peak (e.g., q-value less than 6). By reducing the resonance frequency, the mass of the counterweight can be reduced, thereby resulting in a smaller overall actuator. In addition, the counterweight and the spring-like cap can be configured to simplify assembly of the piezoelectric actuator and/or to improve the resilience of the piezoelectric actuator to mechanical shocks.

The teachings detailed herein are applicable, in at least some implementations, to any type of implantable medical device (e.g., implantable vibration stimulation system or device; bone conduction auditory prosthesis) comprising a first portion implanted on or within the recipient's body and configured to provide vibrations to a portion of the recipient's body. Implementations can include any type of medical device that can utilize the teachings detailed herein and/or variations thereof. Furthermore, while certain implementations are described herein in the context of implantable auditory prosthesis devices, certain other implementations are compatible in the context of other implantable or non-implantable devices or systems (e.g., bone conduction headphones; bone conduction speakers; bone conduction microphones; ultrasonic imaging).

Merely for ease of description, apparatus and methods disclosed herein are primarily described with reference to an illustrative medical device, namely an active transcutaneous or percutaneous bone conduction auditory prosthesis systems. However, the teachings detailed herein and/or variations thereof may also be used with a variety of other medical or non-medical systems that provide a wide range of therapeutic benefits to recipients, patients, or other users. In some implementations, the teachings detailed herein and/or variations thereof can be utilized in other types of devices beyond auditory prostheses that may benefit from a vibration-generating actuator able to fit within a region having restricted space and/or improved control of piezoelectric vibrations (e.g., a direction of vibration motion). Implementations can include any type of auditory prosthesis that can utilize the teachings detailed herein and/or variations thereof. Certain such implementations can be referred to as “partially implantable,” “semi-implantable,” “mostly implantable,” “fully implantable,” or “totally implantable” auditory prostheses. In some implementations, the teachings detailed herein and/or variations thereof can be utilized in other types of prostheses beyond auditory prostheses.

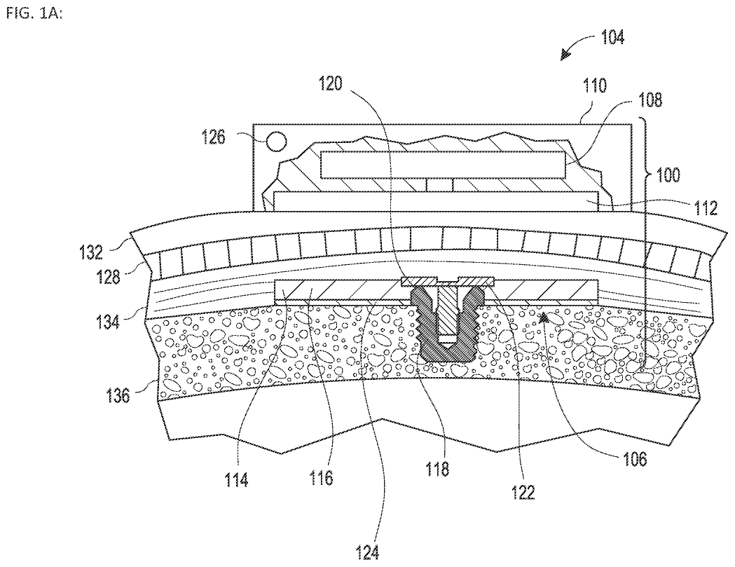

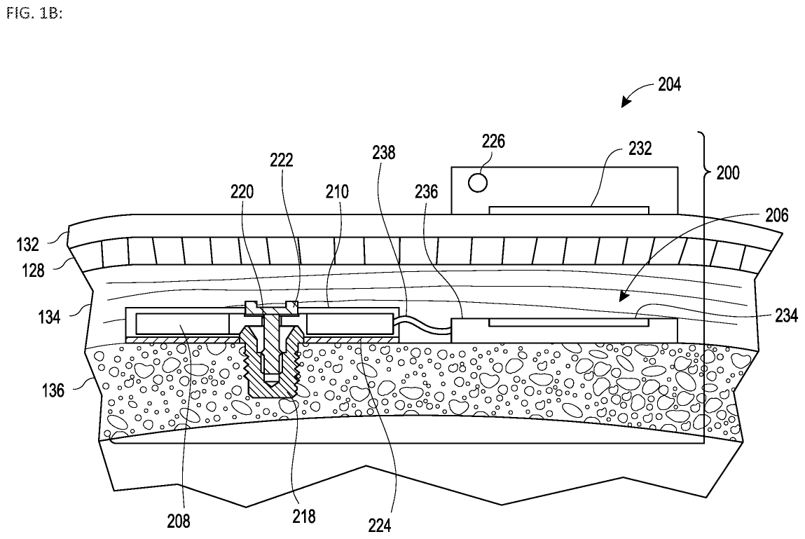

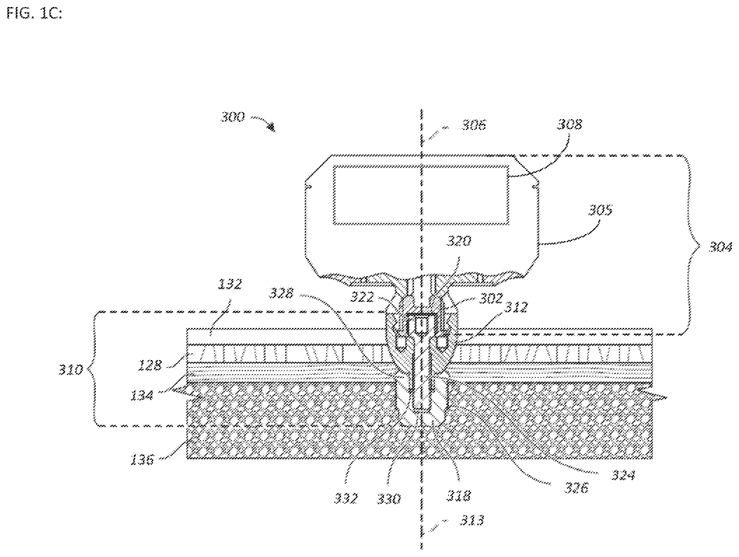

FIG. 1A schematically illustrates a portion of an example transcutaneous bone conduction device 100 implanted in a recipient in accordance with certain implementations described herein. FIG. 1B schematically illustrate a portion of another example transcutaneous bone conduction device 200 implanted in a recipient in accordance with certain implementations described herein. FIG. 1C schematically illustrates a side view of a portion of an example percutaneous bone conduction device 300 in accordance with certain implementations described herein.

The example transcutaneous bone conduction device 100 of FIG. 1A includes an external device 104 and an implantable component 106. The transcutaneous bone conduction device 100 of FIG. 1A is a passive transcutaneous bone conduction device in that a vibrating actuator 108 is located in the external device 104 and delivers vibrational stimuli through the skin 132 to the skull 136. The vibrating actuator 108 is located in a housing 110 of the external component 104 and is coupled to a plate 112. The plate 112 can be in the form of a permanent magnet and/or in another form that generates and/or is reactive to a magnetic field, or otherwise permits the establishment of magnetic attraction between the external device 104 and the implantable component 106 sufficient to hold the external device 104 against the skin 132 of the recipient.

In certain implementations, the vibrating actuator 108 is a device that converts electrical signals into vibration. In operation, a sound input element 126 can convert sound into electrical signals. Specifically, the transcutaneous bone conduction device 100 can provide these electrical signals to the vibrating actuator 108, or to a sound processor (not shown) that processes the electrical signals, and then provides those processed signals to the vibrating actuator 108. The vibrating actuator 108 can convert the electrical signals (processed or unprocessed) into vibrations. Because the vibrating actuator 108 is mechanically coupled to the plate 112, the vibrations are transferred from the vibrating actuator 108 to the plate 112. The implanted plate assembly 114 is part of the implantable component 106, and is made of a ferromagnetic material that may be in the form of a permanent magnet, that generates and/or is reactive to a magnetic field, or otherwise permits the establishment of a magnetic attraction between the external device 104 and the implantable component 106 sufficient to hold the external device 104 against the skin 132 of the recipient. Accordingly, vibrations produced by the vibrating actuator 108 of the external device 104 are transferred from the plate 112 across the skin 132 to a plate 116 of the plate assembly 114. This can be accomplished as a result of mechanical conduction of the vibrations through the skin 132, resulting from the external device 104 being in direct contact with the skin 132 and/or from the magnetic field between the two plates 112, 116. These vibrations are transferred without a component penetrating the skin 132, fat 128, or muscular 134 layers on the head.

In certain implementations, the implanted plate assembly 114 is substantially rigidly attached to a bone fixture 118. The implantable plate assembly 114 can include a through hole 120 that is contoured to the outer contours of the bone fixture 118. This through hole 120 thus forms a bone fixture interface section that is contoured to the exposed section of the bone fixture 118. In certain implementations, the sections are sized and dimensioned such that at least a slip fit or an interference fit exists with respect to the sections. A screw 122 can be used to secure the plate assembly 114 to the bone fixture 118. In certain implementations, a silicone layer 124 is located between the plate 116 and the bone 136 of the skull.

As can be seen in FIG. 1A, the head of the screw 122 is larger than the hole through the implantable plate assembly 114, and thus the screw 122 positively retains the implantable plate assembly 114 to the bone fixture 118. The portions of the screw 122 that interface with the bone fixture 118 substantially correspond to an abutment screw, thus permitting the screw 122 to readily fit into an existing bone fixture used in a percutaneous bone conduction device. In certain implementations, the screw 122 is configured so that the same tools and procedures that are used to install and/or remove an abutment screw from the bone fixture 118 can be used to install and/or remove the screw 122 from the bone fixture 118.

As schematically illustrated by FIG. 1B, an example transcutaneous bone conduction device 200 comprises an external device 204 and an implantable component 206. The device 200 is an active transcutaneous bone conduction device in that the vibrating actuator 208 is located in the implantable component 206. For example, a vibratory element in the form of a vibrating actuator 208 is located in a housing 210 of the implantable component 206. In certain implementations, much like the vibrating actuator 108 described herein with respect to the transcutaneous bone conduction device 100, the vibrating actuator 208 is a device that converts electrical signals into vibration. The vibrating actuator 208 can be in direct contact with the outer surface of the recipient's skull 136 (e.g., the vibrating actuator 208 is in substantial contact with the recipient's bone 136 such that vibration forces from the vibrating actuator 208 are communicated from the vibrating actuator 208 to the recipient's bone 136). In certain implementations, there can be one or more thin non-bone tissue layers (e.g., a silicone layer 224) between the vibrating actuator 208 and the recipient's bone 136 (e.g., bone tissue) while still permitting sufficient support so as to allow efficient communication of the vibration forces generated by the vibrating actuator 208 to the recipient's bone 136.

In certain implementations, the external component 204 includes a sound input element 226 that converts sound into electrical signals. Specifically, the device 200 provides these electrical signals to the vibrating actuator 208, or to a sound processor (not shown) that processes the electrical signals, and then provides those processed signals to the implantable component 206 through the skin of the recipient via a magnetic inductance link. For example, a communication coil 232 of the external component 204 can transmit these signals to an implanted communication coil 234 located in a housing 236 of the implantable component 206. Components (not shown) in the housing 236, such as, for example, a signal generator or an implanted sound processor, then generate electrical signals to be delivered to the vibrating actuator 208 via electrical lead assembly 238. The vibrating actuator 208 converts the electrical signals into vibrations. In certain implementations, the vibrating actuator 208 can be positioned with such proximity to the housing 236 that the electrical leads 238 are not present (e.g., the housing 210 and the housing 236 are the same single housing containing the vibrating actuator 208, the communication coil 234, and other components, such as, for example, a signal generator or a sound processor).

In certain implementations, the vibrating actuator 208 is mechanically coupled to the housing 210. The housing 210 and the vibrating actuator 208 collectively form a vibrating element. The housing 210 can be substantially rigidly attached to a bone fixture 218. In this regard, the housing 210 can include a through hole 220 that is contoured to the outer contours of the bone fixture 218. The screw 222 can be used to secure the housing 210 to the bone fixture 218. As can be seen in FIG. 1B, the head of the screw 222 is larger than the through hole 220 of the housing 210, and thus the screw 222 positively retains the housing 210 to the bone fixture 218. The portions of the screw 222 that interface with the bone fixture 218 substantially correspond to the abutment screw detailed below, thus permitting the screw 222 to readily fit into an existing bone fixture used in a percutaneous bone conduction device (or an existing passive bone conduction device). In certain implementations, the screw 222 is configured so that the same tools and procedures that are used to install and/or remove an abutment screw from the bone fixture 218 can be used to install and/or remove the screw 222 from the bone fixture 218.

The example transcutaneous bone conduction auditory device 100 of FIG. 1A comprises an external sound input element 126 (e.g., external microphone) and the example transcutaneous bone conduction auditory device 200 of FIG. 1B comprises an external sound input element 226 (e.g., external microphone). Other example auditory devices (e.g., totally implantable transcutaneous bone conduction devices) in accordance with certain implementations described herein can replace the external sound input element 126, 226 with a subcutaneously implantable sound input assembly (e.g., implanted microphone).

In certain implementations, the example percutaneous bone conduction device 300 comprises an operationally removable component 304 and a bone conduction implant 310, as schematically illustrated by FIG. 1C. The operationally removable component 304 comprises a housing 305 and is operationally releasably coupled to the bone conduction implant 310. By operationally releasably coupled, it is meant that it is releasable in such a manner that the recipient can relatively easily attach and remove the operationally removable component 304 during normal use of the percutaneous bone conduction device 300, repeatedly if desired. Such releasable coupling is accomplished via a coupling apparatus 302 of the operationally removable component 304 and a corresponding mating apparatus (e.g., abutment 312) of the bone conduction implant 310, as will be detailed below. This operationally releasable coupling is contrasted with how the bone conduction implant 310 is attached to the skull, as will also be detailed below.

The operationally removable component 304 of certain implementations includes a sound input element (e.g., a microphone; a cable or wireless connection configured to receive signals indicative of sound from an audiovisual device), a sound processor (e.g., sound processing circuitry, control electronics, actuator drive components, power module) configured to generate control signals in response to electrical signals from the sound input element, and at least one vibrating actuator 308 configured to generate acoustic vibrations in response to the control signals. The at least one vibrating actuator 308 can comprise a vibrating electromagnetic actuator, a vibrating piezoelectric actuator, and/or another type of vibrating actuator, and the operationally removable component 304 is sometimes referred to herein as a vibrator unit. The control signals are configured to cause the at least one vibrating actuator 308 to vibrate, generating a mechanical output force in the form of acoustic vibrations that is delivered to the skull of the recipient via the bone conduction implant 310. In other words, the operationally removable component 304 converts received sound signals into mechanical motion using the at least one vibrating actuator 308 to impart vibrations to the recipient's skull which are detected by the recipient's ossicles and/or cochlea. In certain implementations, the operationally removable component 304 comprises a single housing 305, as schematically illustrated by FIG. 1C, while in certain other implementations, the operationally removable component 304 comprises a plurality of housings (e.g., separate or different housings, which can have wired and/or wireless connections therebetween).

As schematically illustrated in FIG. 1C, the operationally removable component 304 further includes a coupling apparatus 302 configured to operationally removably attach the operationally removable component 304 to a bone conduction implant 310 (also referred to as an anchor system and/or a fixation system) which is implanted in the recipient. The coupling apparatus 302 can be configured to be repeatedly coupled to and decoupled from the bone conduction implant 310. The coupling apparatus 302 comprises a longitudinal axis 306 (e.g., an axis along a length of the coupling apparatus 302; an axis about which the coupling apparatus 302 is at least partially symmetric). The at least one vibrating actuator 308 of the operationally removable component 304 is in vibrational communication with the coupling apparatus 302 such that vibrations generated by the at least one vibrating actuator 308 are transmitted to the coupling apparatus 302 and then to the bone conduction implant 310 in a manner that at least effectively evokes a hearing percept.

The example bone conduction implant 310 of FIG. 1C comprises a percutaneous abutment 312, a bone fixture 318 (hereinafter sometimes referred to as the fixture 318), and an abutment screw 320. While FIG. 1C illustrates one example bone conduction implant 310 in accordance with certain implementations described herein, other bone conduction implants 310 (e.g., comprising abutments 312, fixtures 318, and/or abutment screws 320 of any type, size/having any geometry) are also compatible with certain implementations described herein.

In certain implementations, the coupling apparatus 302 is configured to be removably attached to the bone conduction implant 310 by pressing the coupling apparatus 302 against the abutment 312 in a direction along (e.g., substantially parallel to) the longitudinal axis 306 of the coupling apparatus 302 and/or along (e.g., substantially parallel to) the longitudinal axis 313 of the abutment 312. In certain such implementations, the coupling apparatus 302 can be configured to be snap-coupled to the abutment 312. In certain implementations, as depicted by FIG. 1C, the coupling apparatus 302 comprises a male component and the abutment 312 comprises a female component configured to mate with the male component of the coupling apparatus 302. In certain implementations, this configuration can be reversed, with the coupling apparatus 302 comprises a female component and the abutment 312 comprises a male component configured to mate with the female component of the coupling apparatus 302.

The abutment 312 of certain implementations is symmetrical with respect to at least those portions of the abutment 312 above the top portion of the fixture 318. For example, the exterior surfaces of the abutment 312 can form concentric outer profiles about a longitudinal axis 313 of the abutment 312 (e.g., an axis along a length of the abutment 312; an axis about which the abutment 312 is at least partially symmetric). As shown in FIG. 1C, the exterior surfaces of the abutment 312 establish diameters lying on planes normal to the longitudinal axis 313 that vary along the length of the longitudinal axis 313. For example, the abutment 312 can include outer diameters that progressively become larger with increased distance from the fixture 318. In certain other implementations, the outer diameters can have other outer profiles.

In certain implementations, the abutment 312 is configured for integration between the skin and the abutment 312. Integration between the skin and the abutment 312 can be considered to occur when the soft tissue of the skin 132 encapsulates the abutment 312 in fibrous tissue and does not readily dissociate itself from the abutment 312, which can inhibit the entrapment and/or growth of microbes proximate the bone conduction implant 310. For example, the abutment 312 can have a surface having features which are configured to reduce certain adverse skin reactions. In certain implementations, the abutment 312 is coated to reduce the shear modulus, which can also encourage skin integration with the abutment 213. For example, at least a portion of the abutment 312 can be coated with or otherwise contain a layer of hydroxyapatite that enhances the integration of skin with the abutment 312.

In certain implementations, the abutment 312 is configured to be attached to the fixture 318 via the abutment screw 320, and the fixture 318 is configured to be fixed to (e.g., screwed into) the recipient's skull bone 136. The abutment 312 extends from the fixture 318, through muscle 134, fat 128, and skin 132 so that the coupling apparatus 140 can be attached thereto. The abutment screw 320 (e.g., comprising a screw head 322 and an elongate coupling shaft 324 connected to the screw head 322) connects and holds the abutment 312 to the fixture 318, thereby rigidly attaching the abutment 312 to the fixture 318. The rigid attachment is such that the abutment 312 is vibrationally connected to the fixture 318 such that at least some of the vibrational energy transmitted to the abutment 312 is transmitted to the fixture 318 in a sufficient manner to effectively evoke a hearing percept (e.g., to mechanically vibrate the skull bone of the recipient, the vibrations received by the recipient's cochlea to compensate for conductive hearing loss, mixed hearing loss, or single-sided deafness). The percutaneous abutment 312 provides an attachment location for the coupling apparatus 302 that facilitates efficient transmission of mechanical force.

The fixture 318 can be made of any material that has a known ability to integrate into surrounding bone tissue (e.g., comprising a material that exhibits acceptable osseointegration characteristics). In certain implementations, the fixture 318 is formed from a single piece of material (e.g., titanium) and comprises outer screw threads 326 forming a male screw which is configured to be installed into the skull bone 136 and a flange 328 configured to function as a stop when the fixture 318 is implanted into the skull bone 136. The screw threads 326 can have a maximum diameter of about 3.5 mm to about 5.0 mm, and the flange 328 can have a diameter which exceeds the maximum diameter of the screw threads 326 (e.g., by approximately 10%-20%). The flange 328 can have a planar bottom surface for resting against the outer bone surface, when the fixture 318 has been screwed down into the skull bone 136. The flange 328 prevents the fixture 318 (e.g., the screw threads 326) from potentially completely penetrating completely through the bone 136.

The body of the fixture 318 can have a length sufficient to securely anchor the fixture 318 to the skull bone 136 without penetrating entirely through the skull bone 136. The length of the body can therefore depend on the thickness of the skull bone 136 at the implantation site. For example, the fixture 318 can have a length, measured from the planar bottom surface of the flange 328 to the end of the distal region (e.g., the portion farthest from the flange 328), that is no greater than 5 mm or between about 3.0 mm to about 5.0 mm, which limits and/or prevents the possibility that the fixture 318 might go completely through the skull bond 136.

The interior of the fixture 318 can further include an inner lower bore 330 having female screw threads configured to mate with male screw threads of the elongate coupling shaft 324 to secure the abutment screw 320 and the abutment 312 to the fixture 318. The fixture 318 can further include an inner upper bore 332 that receives a bottom portion of the abutment 312. While FIG. 1C shows the coupling apparatus 302 directly engaging with (e.g., directly contacting) the abutment screw 320 (e.g., the screw head 322), in certain other implementations, the coupling apparatus 302 engages with the abutment 312 without directly engaging with (e.g., without directly contacting) the abutment screw 320.

In certain implementations, the bottom of the abutment 312 includes a fixture connection section extending below a reference plane extending across the top of the fixture 318 and that interfaces with the fixture 318. Upon sufficient tensioning of the abutment screw 320, the abutment 312 sufficiently elastically and/or plastically stresses the fixture 318, and/or visa-versa, so as to form a tight seal at the interface of surfaces of the abutment 312 and the fixture 318. Certain such implementations can reduce (e.g., eliminate) the chances of micro-leakage of microbes into the gaps between the abutment 312, the fixture 318 and the abutment screw 320.

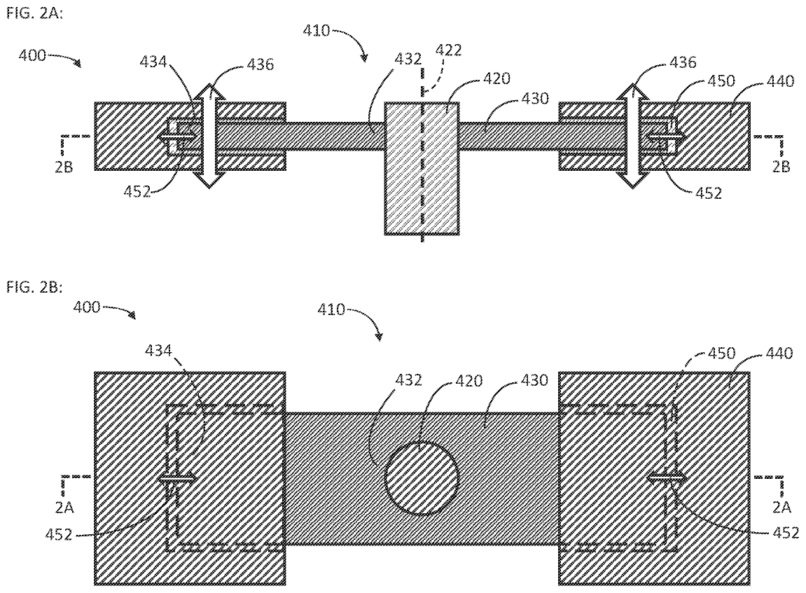

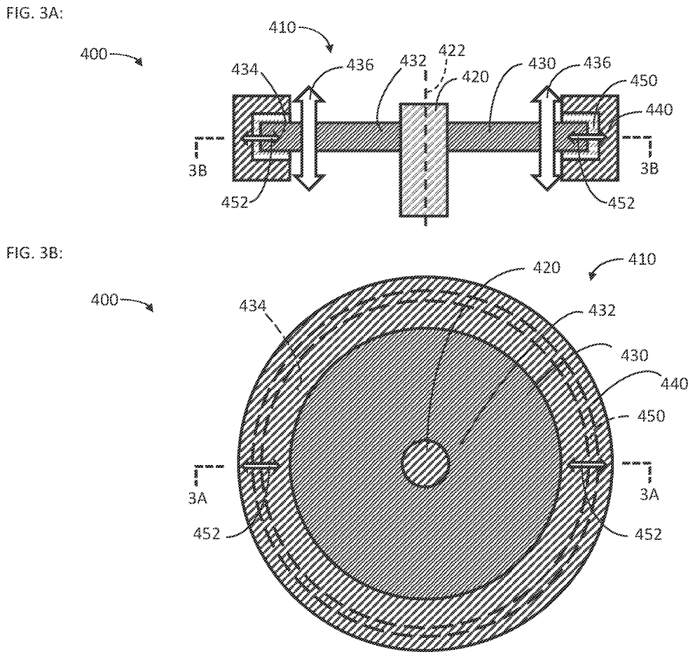

FIGS. 2A-2B schematically illustrate a side cross-sectional view and a top cross-sectional view, respectively, of an example apparatus 400 in accordance with certain implementations described herein. FIGS. 3A-3B schematically illustrate a side cross-sectional view and a top cross-sectional view, respectively, of another example apparatus 400 in accordance with certain implementations described herein. For example, the apparatus 400 of FIGS. 2A-2B and/or 3A-3B can be an external component 104 of a passive transcutaneous bone conduction device 100 as schematically illustrated in FIG. 1A, an implantable component 206 of an active transcutaneous bone conduction device 200 as schematically illustrated in FIG. 1B, or an operationally removable component 304 of a percutaneous bone conduction device 300 as schematically illustrated in FIG. 1C.

The example apparatus 400 of certain implementations comprises an actuator 410 configured to generate vibrations. The actuator 410 comprises a coupling portion 420 configured to be in operative communication with a fixture (e.g., bone fixture 118, 218, 318) implanted on or within a recipient's body. The actuator 410 further comprises a substantially planar piezoelectric oscillator 430 having a central portion 432 substantially surrounding and in mechanical communication with the coupling portion 420 and a peripheral portion 434 spaced from the coupling portion 420. The piezoelectric oscillator 430 is configured to undergo bending oscillations 436 in response to received electric voltage signals. The actuator 410 further comprises at least one mass 440 in mechanical communication with the peripheral portion 434. The at least one mass 440 is configured to move in response to the bending oscillations 436 of the piezoelectric oscillator 430. The actuator 410 further comprises at least one coupler 450 mechanically attached at least to the peripheral portion 434 and the at least one mass 440. The at least one coupler 450 is configured to allow expansion and contraction 452 of the peripheral portion 434 along a first direction substantially parallel to the piezoelectric oscillator 430 and to inhibit movement of the peripheral portion 434 relative to the at least one mass 440 along a second direction substantially perpendicular to the piezoelectric oscillator 430.

In certain implementations, the actuator 410 is a vibrating actuator 108 within a housing 110 external to the recipient's body, and the coupling portion 420 comprises at least one elongate structure (e.g., cylindrical element; post; screw) affixed to a plate 112 (e.g., permanent magnet and/or other ferromagnetic or ferrimagnetic element) that is magnetically attracted to a corresponding implanted plate assembly 114 substantially rigidly attached to a bone fixture 118. In certain other implementations, the actuator 410 is a vibrating actuator 208 within a housing 210 implanted on or within the recipient's body, and the coupling portion 420 comprises at least one elongate structure 220 (e.g., cylindrical element; post; screw 222) affixed to a bone fixture 218 (e.g., via a clamp, screw, adhesive, or other coupler). In certain other implementations, the actuator 410 is a vibrating actuator 308 within an external housing 305 having a coupling apparatus 302 that is configured to mate with an abutment 312 of the bone conduction implant 310, and the coupling portion 420 comprises at least one elongate structure (e.g., cylindrical element; post; screw) in mechanical communication with the bone fixture 318 via the coupling apparatus 302 and the abutment 312.

In certain implementations, the housing 110, 210, 305 is configured to hermetically seal the at least one mass 450 and the piezoelectric oscillator 430 from an environment surrounding the actuator 410. The housing 110, 210, 305 can have a length and/or a width less than or equal to 40 millimeters (e.g., in a range of 15 millimeters to 35 millimeters; in a range of 25 millimeters to 35 millimeters; in a range of less than 30 millimeters; in a range of 15 millimeters to 30 millimeters), and/or a thickness less than or equal to 7 millimeters (e.g., in a range of less than or equal to 6 millimeters, in a range of less than or equal to 5 millimeters; in a range of less than or equal to 4 millimeters). The housing 110, 210, 305 of certain implementations comprises at least one biocompatible material (e.g., plastic; PEEK; silicone; ceramic; zirconium oxide).

In certain implementations, the actuator 410 is configured to generate vibrational energy (e.g., vibrations) within a range of vibrational frequencies that are perceptible by the recipient as sound (e.g., a range of 20 Hz to 20 kHz), which are referred to herein as auditory vibrations. The coupling portion 420 is part of a propagation path for the auditory vibrations to be transmitted to the fixture (e.g., bone fixture 118, 218, 318) and to propagate via bone conduction from the fixture to an inner ear region (e.g., within the temporal bone and comprising the vestibule, the cochlea, and the semicircular canals) and/or a middle ear region (e.g., within the recipient's head, partially bounded by the tympanic membrane and comprising the ossicles, the round window, the oval window, and the Eustachian tube) to be detected as sound.

In certain implementations, the piezoelectric oscillator 430 comprises a unitary (e.g., single; monolithic) component comprising at least one piezoelectric material. The piezoelectric oscillator 430 of certain implementations comprises two or more layers in mechanical communication with one another (e.g., bonded together) into a unitary component (e.g., a stack), at least one of the layers comprising at least one piezoelectric material (e.g., unimorph having one piezoelectric layer and a non-piezoelectric layer; bimorph having two or more piezoelectric layers). The unitary component can comprise other non-piezoelectric materials, such as a bonding material (e.g., adhesive; epoxy; metal) between piezoelectric layers, electrically conductive material (e.g., metal) configured to apply electrical voltage signals to the at least one piezoelectric material, and/or a non-piezoelectric layer (e.g., metal backplate) affixed to the at least one piezoelectric material. In certain implementations, the number of layers of the piezoelectric oscillator 430 are selected to provide a predetermined power, size (e.g., area, thickness), stiffness, and/or resonance frequency. Examples of piezoelectric materials compatible with certain implementations described herein include but are not limited to: quartz; gallium orthophosphate; langasite; barium titanate; lead titanate; lead zirconate titanate (PZT); potassium niobate; lithium niobate; lithium tantalate; sodium tungstate; sodium potassium niobate; bismuth ferrite; sodium niobate; polyvinylidene fluoride; macro fiber composite (MFC); other piezoelectric crystals, ceramics, or polymers.

In certain implementations, the piezoelectric oscillator 430 is substantially planar (e.g., plate; sheet; disc-shaped). For example, the piezoelectric oscillator 430 can be a generally rectangular plate as schematically illustrated by FIGS. 2A-2B or a generally circular disk as schematically illustrated by FIGS. 3A-3B. Other planar shapes are also compatible with certain implementations described herein (e.g., oval; polygonal with 5, 6, 7, 8, or more sides; geometric; non-geometric; regular; irregular). In certain implementations, the piezoelectric oscillator 430 has a length (e.g., in a range of 2 millimeters to 20 millimeters), a width substantially perpendicular to the length (e.g., in a range of 2 millimeters to 20 millimeters), and a thickness substantially perpendicular to the length and to the width (e.g., in a range of less than 2 millimeters; less than 1 millimeter; greater than 300 microns). Various configurations and geometries of the piezoelectric oscillator 430 are compatible with certain implementations described herein (see, e.g., “Piezoelectric Ceramic Products: Fundamentals, Characteristics and Applications,” Physik Instruments (PI) GmbH & Co., Lederhose, Germany, www.piceramic.com, (2016)).

In certain implementations, the central portion 432 of the piezoelectric oscillator 430 is affixed to the coupling portion 420 (e.g., via a clamp, screw, adhesive, or other coupler) and does not substantially move relative to the coupling portion 420 during the bending oscillations 436 of the piezoelectric oscillator 430. For example, the central region 432 can comprise a hole (e.g., the hole has an inner perimeter that is part of the central region 432) with the coupling portion 420 extending from the fixture along a longitudinal axis 422, the piezoelectric oscillator 430 extending along a plane substantially perpendicular to the longitudinal axis 422, and the coupling portion 420 extending through the hole and affixed to the surrounding central region 432.

In certain implementations, the peripheral portion 434 of the piezoelectric oscillator 430 is configured to substantially move relative to the coupling portion 420 during the bending oscillations 436 of the piezoelectric oscillator 430 (e.g., in response to time-varying electrical voltage signals applied across portions of the piezoelectric oscillator 430). For example, the peripheral portion 434 can comprise at least a portion of a perimeter of the piezoelectric oscillator 430 and is in mechanical communication with the at least one mass 440 via the at least one coupler 450, such that the bending oscillations 436 move the peripheral portion 434 and the at least one mass 440 along a direction substantially parallel to the longitudinal axis 422 of the coupling portion 420 (e.g., substantially perpendicular to the piezoelectric oscillator 430).

In certain implementations, the at least one mass 440 comprises one or more materials having sufficiently large mass density and dimensions (e.g., length; width; thickness; volume) such that the at least one mass 400 has a mass (e.g., weight) configured to achieve a predetermined resonant frequency for the bending oscillations 436 (e.g., the generated vibrations) (e.g., in a range of 250 Hz to 3 kHz; about 750 Hz). Examples of such materials of the at least one mass 440 include but are not limited to: tungsten; tungsten alloy; osmium; osmium alloy. The at least one mass 440 can comprise a unitary (e.g., single; monolithic) component, multiple components (e.g., two or more sub-masses) that are affixed to one another, and/or multiple components that are separate from one another. In certain implementations, the at least one mass 440 comprises separate masses 440 positioned at separate locations at the peripheral portion 434 of the piezoelectric oscillator 430. For example, as schematically illustrated in FIGS. 2A-2B, the at least one mass 440 comprises two separate masses 440 positioned at opposite ends of the substantially rectangular piezoelectric oscillator 430 spaced from the coupling portion 420. In certain other implementations, the at least one mass 440 extends substantially completely around a perimeter of the piezoelectric oscillator 430. For example, as schematically illustrated in FIGS. 3A-3B, the at least one mass 440 is substantially circular and is positioned at and concentrically around a perimeter of the substantially circular piezoelectric oscillator 430.

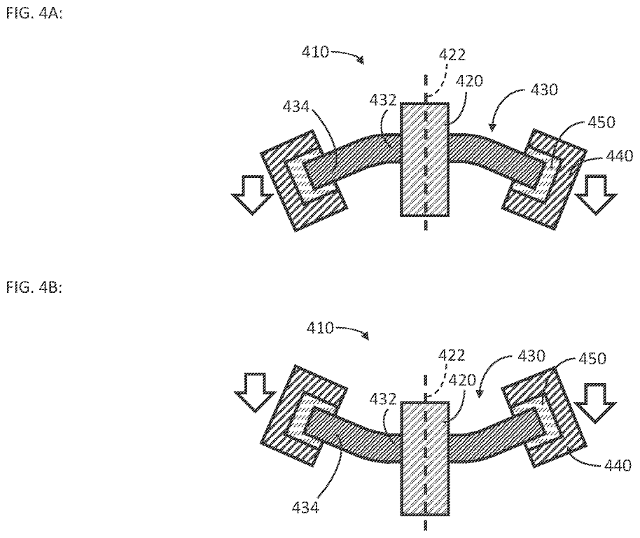

FIGS. 4A-4B schematically illustrate two example shapes of the piezoelectric oscillator 430 during the bending oscillations 436 in accordance with certain implementations described herein. The piezoelectric oscillator 430 generates vibrational energy by changing shape in response to received time-varying electrical voltage signals. In response to the shape changes, the at least one mass 440 moves relative to the coupling portion 420 (e.g., along a direction substantially parallel to the longitudinal axis 422 of the coupling portion 420). In certain implementations, the piezoelectric oscillator 430 is configured to change between a convex shape (e.g., having the perimeter of the piezoelectric oscillator 430 below an equilibrium position of the perimeter corresponding to no electrical voltage being applied to the piezoelectric oscillator 430; see, e.g., FIG. 4A) and a concave shape (e.g., having the perimeter of the piezoelectric oscillator 430 above the equilibrium position of the perimeter corresponding to no electrical voltage being applied to the piezoelectric oscillator 430; see, e.g., FIG. 4B). For example, for a substantially circular and planar piezoelectric oscillator 430 (e.g., disk-shaped; an example of which is schematically illustrated by FIGS. 3A-3B), the convex shape is substantially dome-shaped and the concave shape is substantially bowl-shaped. In response to electrical voltage signals that apply oscillating positive and negative voltages across at least a portion of the piezoelectric oscillator 430, the piezoelectric oscillator 430 oscillates or vibrates between the convex and concave shapes.

In certain implementations, the at least one coupler 450 comprises at least one resilient element that is mechanically affixed to the peripheral portion 434 and to the at least one mass 440 and is configured to allow movement of the peripheral portion 434 of the piezoelectric oscillator 430 relative to the at least one mass 440 in a direction generally parallel to the substantially planar piezoelectric oscillator 430. For example, for a substantially circular and planar piezoelectric oscillator 430 (e.g., disk-shaped; an example of which is schematically illustrated by FIGS. 3A-3B), the at least one coupler 450 is configured to allow radial relative movements between the peripheral portion 434 and the at least one mass 440, the radial relative movements substantially parallel to the peripheral portion 434. The at least one coupler 450 is further configured to inhibit non-radial relative movements between the peripheral portion 434 and the at least one mass 440, the non-radial relative movements substantially perpendicular to the peripheral portion 434. The at least one resilient element can comprise various shapes, dimensions, and materials compatible with the various example apparatus 400 described herein.

FIG. 5A schematically illustrates a cross-sectional perspective view of an example actuator 410 in accordance with certain implementations described herein. FIG. 5B schematically illustrates a portion of the example actuator 410 of FIG. 5A. FIG. 5C schematically illustrates a perspective view of the example actuator 410 of FIG. 5A. The coupling portion 420 is not shown in FIGS. 5A-5C. The piezoelectric oscillator 430 of FIGS. 5A-5C is substantially planar and circular (e.g., disk-shaped) having a central portion 432 bounding a central hole 460 having an inner perimeter 462 configured to be affixed to the coupling portion 420. The piezoelectric oscillator 430 also has a peripheral portion 434 comprising an outer perimeter 464 of the piezoelectric oscillator 430.

The at least one mass 440 of FIGS. 5A-5C is substantially circular (e.g., disk-shaped; ring-shaped) and is in mechanical communication with the peripheral portion 434 while not substantially inhibiting bending of the piezoelectric oscillator 430. In certain implementations, the at least one mass 440 at least partially bounds a region 442 below the piezoelectric oscillator 430 and surrounding the coupling portion 420, the region 442 configured to contain circuitry for operation of the apparatus 400. In certain implementations, as schematically illustrated in FIGS. 5A-5C, most of the at least one mass 440 is below the piezoelectric oscillator 430, while in certain other implementations, most of the at least one mass 440 is above the piezoelectric oscillator 430 or the at least one mass 440 is substantially evenly distributed above and below the piezoelectric oscillator 430. By having most of the at least one mass 440 below the piezoelectric oscillator 430 and/or having the region 442 below the piezoelectric oscillator 430 containing the circuitry, certain implementations can provide an actuator 410 having a smaller height than conventional actuators.

The at least one coupler 450 of FIGS. 5A-5C comprises a substantially circular (e.g., disk-shaped; ring-shaped) resilient (e.g., elastically compressible; flexible) material 454 (e.g., silicone; elastomer; rubber; Viton™ fluoroelastomer) that substantially surrounds the outer perimeter 464 of the piezoelectric oscillator 430. For example, as schematically illustrated by FIGS. 5A-5B, the resilient material 454 can define a region configured to contain the outer perimeter 464 of the piezoelectric oscillator 430. The resilient material 454 is configured to keep the peripheral portion 434 of the piezoelectric oscillator 430 in mechanical communication with the at least one mass 440 while allowing the peripheral portion 434 to expand and contract along the radial direction (e.g., along a direction from the coupling portion 420 to the outer perimeter 464). In this way, the substantially circular and planar piezoelectric oscillator 430 can undergo bending oscillations without being substantially inhibited by a rigid mechanical connection between the peripheral portion 434 and the at least one mass 440.

The at least one coupler 450 of FIGS. 5A-5C further comprises at least one rigid material 456 (e.g., metal; aluminum; spring steel) that is substantially circular (e.g., disk-shaped; ring-shaped) and that extends substantially completely around the piezoelectric oscillator 430. For example, as schematically illustrated by FIGS. 5A-5B, the resilient material 454 can comprise a substantially planar rigid portion 457 and a spring portion 458. The at least one rigid material 456 is configured to be affixed to the at least one mass 440 (e.g., via the spring portion 458 being snap-coupled to the at least one mass 440) with the peripheral portion 434 of the piezoelectric oscillator 430 between the rigid portion 457 and the at least one mass 440. For example, the at least one mass 440 can have contours around its perimeter configured to receive respective contours of the spring portion 458 such that the at least one mass 440 and the at least one coupler 450 are configured to be press-fitted together (e.g., snap-fitted) with the peripheral portion 434 sandwiched between the at least one mass 440 and the at least one coupler 450.

In certain implementations, as shown in FIGS. 5A-5C, a first surface 444 of the at least one mass 440 and a second surface 470 of the rigid portion 457 can at least partially bound a region containing the resilient material 454 and the outer perimeter 464 of the piezoelectric element 430. The first surface 444 and the second surface 470 are configured to compress the resilient material 454 above and below the peripheral portion 434 of the piezoelectric oscillator 430, thereby inhibiting the peripheral portion 434 from moving relative to the at least one mass 440 along a direction substantially perpendicular to the piezoelectric oscillator 430. The resilient material 454 on the outer perimeter 464 of the piezoelectric oscillator 430 is configured to allow radial expansion and contraction of the peripheral portion 434 along a direction substantially parallel to the piezoelectric oscillator 430. By having the at least one mass 440 and the at least one coupler 450 configured to be press-fitted together, certain implementations can provide an actuator 410 that is easier and/or more cost-effective to assembly. In certain other implementations, the at least one mass 440 and the at least one coupler 450 can be affixed to one another by other means (e.g., one or more clips, clamps, welds, or rivets; screws or screw threads; plastically deforming one or both of the at least one mass 440 and the at least one coupler 450).

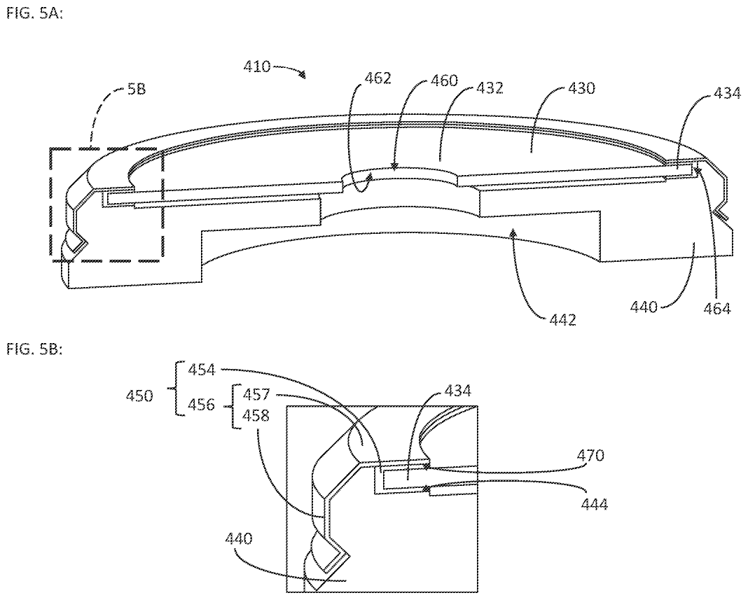

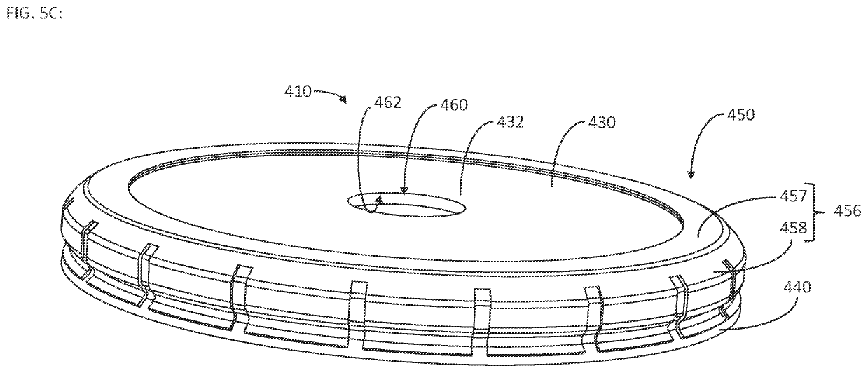

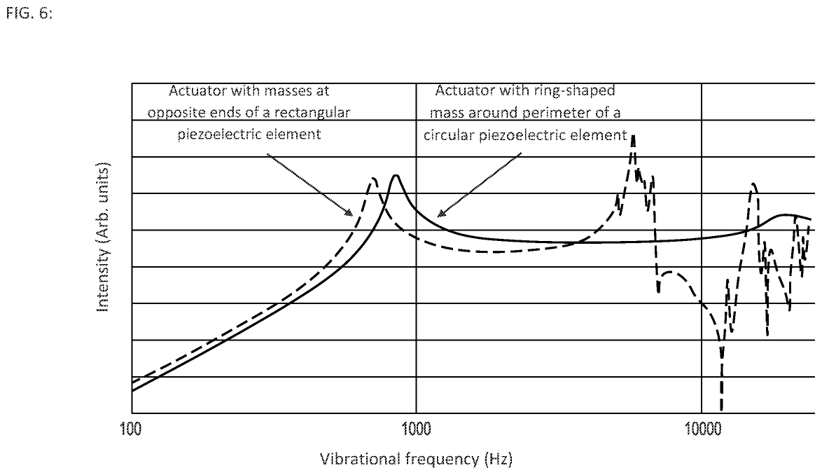

FIG. 6 schematically illustrates modeling of a conventional vibrational frequency distribution and an example vibrational frequency distribution generated by an actuator 410 in accordance with certain implementations described herein. The conventional vibrational frequency distribution corresponds to an actuator comprises a rectangular piezoelectric element having masses rigidly affixed to end portions of the piezoelectric element. The example vibrational frequency distribution corresponds to an actuator 410 having the structure schematically illustrated by FIGS. 5A-5C with the ring-shaped mass 440 resiliently affixed around the outer perimeter 464 of a substantially circular and planar piezoelectric oscillator 430 by the at least one coupler 450. As shown in FIG. 6, the modelled conventional vibrational frequency distribution has a first resonance at about 800 Hz and a substantial second resonance at about 7 kHz. Because this second resonance is within the range of human hearing, it can cause operational problems for conventional bone conduction auditory prostheses. In contrast, while the modelled example vibrational frequency distribution also has a first resonance, shifted slightly to a higher frequency at about 900 Hz, the second resonance of the modelled example vibrational frequency distribution is relatively small and is shifted to a much higher frequency at about 20 kHz (e.g., out of the range of human hearing). This modelled example vibrational frequency distribution indicates that certain implementations as described herein can provide vibrational frequency distributions that are configured for bone conduction auditory prostheses and that do not require filtering circuitry or other means for inhibiting the second resonance from interfering with operation of the auditory prosthesis.

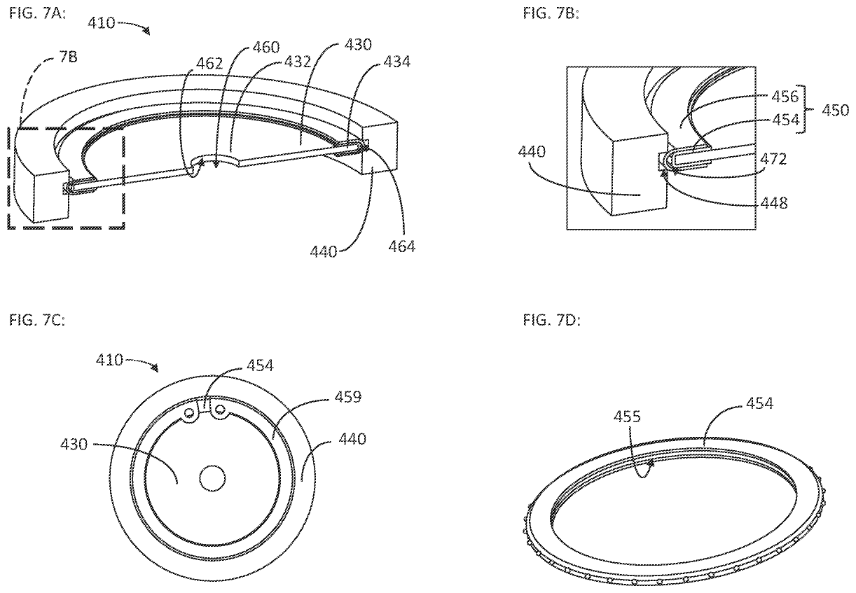

FIG. 7A schematically illustrates a cross-sectional perspective view of another example actuator 410 in accordance with certain implementations described herein. FIG. 7B schematically illustrates a portion of the example actuator 410 of FIG. 7A. FIG. 7C schematically illustrates a top view of another example actuator 410 in accordance with certain implementations described herein. The coupling portion 420 is not shown in FIGS. 7A-7C. FIG. 7D schematically illustrates a perspective view of an example resilient material 454 compatible with the example actuator 410 of FIGS. 7A-7C.

The piezoelectric oscillator 430 of FIGS. 7A-7C is substantially planar and circular (e.g., disk-shaped) having a central portion 432 bounding a central hole 460 having an inner perimeter 462 configured to be affixed to the coupling portion 420. The piezoelectric oscillator 430 also has a peripheral portion 434 comprising an outer perimeter 464 of the piezoelectric oscillator 430. The at least one mass 440 comprises a unitary (e.g., monolithic; single) substantially circular (e.g., ring-shaped) mass 440 having an inner perimeter and comprising a groove 448 having edges and/or sides that are configured to be engaged by (e.g., in mechanical contact with) the at least one coupler 450.

The at least one coupler 450 of FIGS. 7A-7B comprises a substantially circular (e.g., ring-shaped) resilient (e.g., elastically compressible; flexible) material 454 (e.g., silicone; elastomer; rubber; Viton™ fluoroelastomer) that substantially surrounds the outer perimeter 464 of the piezoelectric oscillator 430. The at least one coupler 450 further comprises at least one rigid material 456 (e.g., metal; aluminum; spring steel) that is substantially circular (e.g., ring-shaped). In certain implementations, the resilient material 454 and the rigid material 456 extend completely around the piezoelectric oscillator 430. In certain other implementations, as schematically illustrated by FIG. 7C, the at least one rigid material 456 comprises a C-spring having two ends with a gap therebetween, the C-spring configured to be compressed while being snapped into the groove 448, with the C-spring expanding into and engaging the groove 448.

In certain implementations, as schematically illustrated by FIGS. 7A-7B, the resilient material 454 can define a region 455 configured to contain the outer perimeter 464 of the piezoelectric oscillator 430 and the rigid material 456 can comprise a metal (e.g., aluminum; steel) channel (e.g., having a U-shaped cross-section) configured to contain the resilient material 454 and the outer perimeter 464 of the piezoelectric oscillator 430. In certain implementations, the channel is configured to be snap-fitted into the groove 448 such that the mass 440 is in mechanical communication with the peripheral portion 434 while not substantially inhibiting bending of the piezoelectric oscillator 430.

The resilient material 454 is configured to keep the peripheral portion 434 of the piezoelectric oscillator 430 in mechanical communication with the mass 440 while allowing the peripheral portion 434 to expand and contract along the radial direction (e.g., along a direction from the coupling portion 420 to the outer perimeter 464). In this way, the substantially circular and planar piezoelectric oscillator 430 can undergo bending oscillations without being substantially inhibited by a rigid mechanical connection between the peripheral portion 434 and the mass 440. As schematically illustrated by FIGS. 7A-7B, the rigid material 456 is engaged by the groove 448 with the groove 448 substantially coplanar with and substantially surrounding the outer perimeter 464 of the piezoelectric oscillator 430. In certain implementations, as schematically illustrated by FIG. 7B, the resilient material 454 and the peripheral portion 434 of the piezoelectric oscillator 430 do not completely fill the metal channel of the at least one coupler 450, thereby providing a region 472 into which the peripheral portion 434 can expand into and retract from during the bending oscillations. In certain other implementations, the channel is completely filled by the resilient material 454 and the peripheral portion 434.

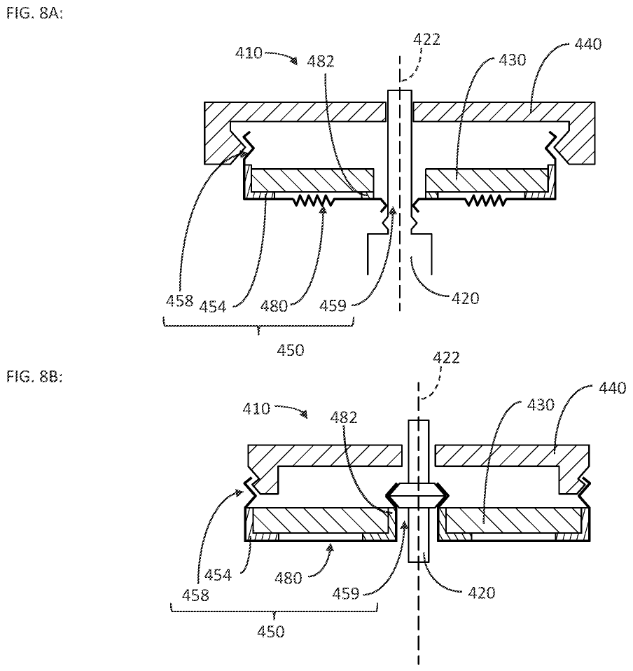

FIGS. 8A and 8B schematically illustrate cross-sectional views of two example actuators 410 that are substantially cylindrically symmetric about the longitudinal axis 422 of the coupling portion 420 in accordance with certain implementations described herein. The at least one coupler 450 of each of FIGS. 8A and 8B comprises the resilient (e.g., elastically compressible; flexible) material 454 and a substantially planar and bendable portion 480 (e.g., a backplate) affixed to the peripheral portion 434 of the piezoelectric oscillator 430 (e.g., by the resilient material 454) and affixed to the central portion 432 of the piezoelectric oscillator 430 (e.g., by epoxy 482). The resilient material 454 is contacting the peripheral portion 434 of the piezoelectric oscillator 430. The at least one coupler 450 further comprises a first spring portion 458 affixed to the at least one mass 440 (e.g., via a snap-coupling) and further comprises a second spring portion 459 affixed (e.g., via a compression fitting) to the coupling portion 420.

As shown in FIG. 8A, the first spring portion 458 can be affixed (e.g., snap-coupled) to an inner surface of the at least one mass 440 (e.g., such that the at least one mass 440 extends radially past an outermost portion of the at least one coupler 450). As shown in FIG. 8B, the first spring portion 458 of FIG. 8B can be affixed (e.g., snap-coupled) to an outer surface of the at least one mass 440 (e.g., such that the at least one mass 440 does not extend radially past an outermost portion of the at least one coupler 450). The second spring portion 459 can be affixed (e.g., snap-coupled) to an inner surface or an outer surface of the coupling portion 420.

In certain implementations, the substantially planar and bendable portion 480 is configured to not substantially inhibit bending of the piezoelectric oscillator 430 (e.g., the portion 480 bending with the bending of the piezoelectric oscillator 430; the portion 480 radially expanding and contracting with radial expansion and contraction of the piezoelectric oscillator 430). The resilient material 454 is configured to not substantially inhibit bending of the piezoelectric oscillator 430 while mechanically coupling the piezoelectric oscillator 430 to the at least one coupler 450 (e.g., the resilient material 454 allowing the peripheral portion 434 of the piezoelectric oscillator 430 to expand and contract along the radial direction).

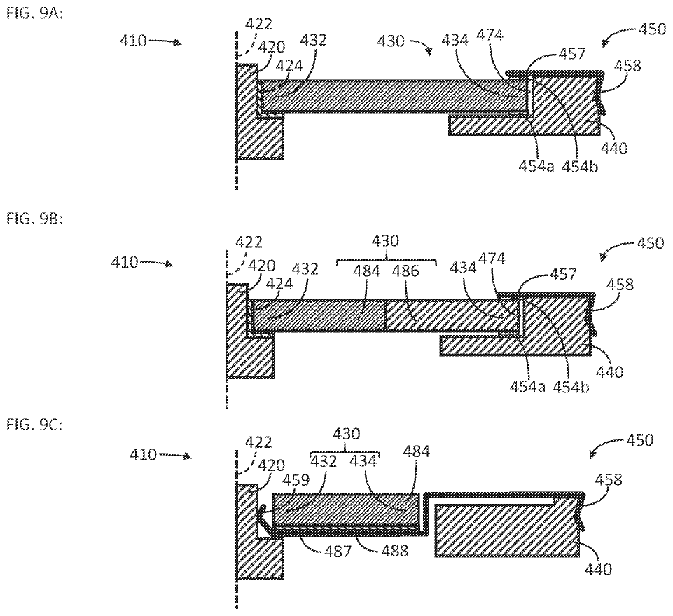

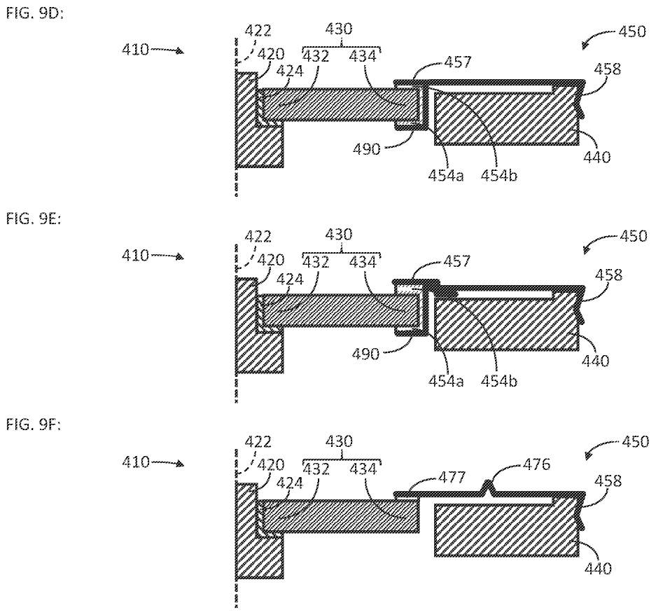

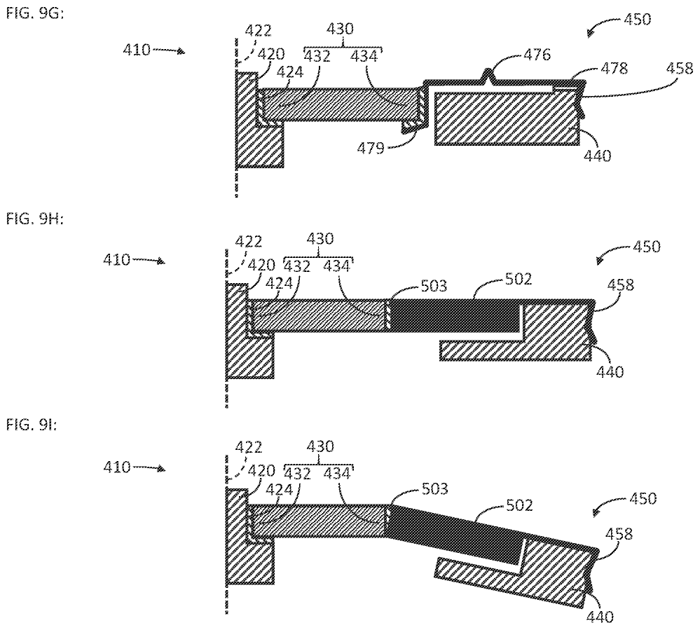

FIGS. 9A-9I schematically illustrate cross-sectional views of portions of various example actuators 410 in accordance with certain implementations described herein. In certain implementations, the example actuators 410 of FIGS. 9A-9I are substantially cylindrically symmetric about the longitudinal axis 422 of the coupling portion 420 and FIGS. 9A-9I each show a cross-sectional view of an example actuator 410 on one side of the longitudinal axis 422. For each example actuator 410 of FIGS. 9A-9I, the piezoelectric oscillator 430 extends along a plane substantially perpendicular to the longitudinal axis 422 and the at least one coupler 450 comprises a first spring portion 458 affixed (e.g., snap-coupled) to the at least one mass 440. The central portion 432 of the piezoelectric oscillator 430 substantially surrounds the coupling portion 420 and is affixed to the coupling portion 420 (e.g., via epoxy 424 in FIGS. 9A, 9B, and 9D-9I and via a second spring portion 459 of the at least one coupler 450 in FIG. 9C).

As schematically illustrated in FIG. 9A, in certain implementations, the at least one coupler 450 comprises a substantially planar rigid portion 457, a first portion 454a of the resilient material 454 sandwiched between the rigid portion 457 and the peripheral portion 434, and a second portion 454b of the resilient material 454 sandwiched between the at least one mass 440 and the peripheral portion 434. The actuator 410 of FIG. 9A is similar to that of FIGS. 5A-5C, but while the resilient material 454 of FIGS. 5A-5B extends from above the peripheral portion 434 to below the peripheral portion 434 (e.g., substantially surrounding the outer perimeter 464 of the piezoelectric oscillator 430), the resilient material 454 of FIG. 9A has the first portion 454a positioned above the peripheral portion 434 and the second portion 454b positioned below the peripheral portion 434 with a gap 474 therebetween, the gap 474 between the outer perimeter 464 and the at least one mass 440 and configured to provide space for the expansion and contraction of the peripheral portion 434.

As schematically illustrated in FIG. 9B, in certain implementations, the piezoelectric oscillator 430 comprises an active portion 484 comprising the at least one piezoelectric material and a passive portion 486 (e.g., comprising metal; steel; aluminum) that does not comprise a piezoelectric material. The passive portion 486 is affixed to an edge portion of the active portion 484 (e.g., by epoxy) such that the width (e.g., diameter) of the piezoelectric oscillator 430 is larger than that of the active portion 484. For example, the active portion 484 can comprise a disk-shaped piezoelectric element affixed to the coupling portion 420 and a rigid non-piezoelectric element affixed to the piezoelectric element at a first radial distance from the coupling portion 420 and extending to a second radial distance from the coupling portion 420, the second radial distance larger than the first radial distance. The passive portion 486 comprises the peripheral portion 434 of the piezoelectric oscillator 430 and is mechanically coupled to the at least one mass 440 by the at least one coupler 450 (e.g., the first and second portions 454a,b of the resilient material 454, the rigid portion 457, and the spring portion 458), as described herein with regard to FIG. 9A.

As schematically illustrated in FIG. 9C, in certain implementations, the piezoelectric oscillator 430 comprises an active portion 484 comprising the at least one piezoelectric material and the at least one coupler 450 can comprises a backplate 488 (e.g., comprising metal; steel; aluminum) that does not comprise a piezoelectric material, the backplate 488 affixed (e.g., via epoxy 487) to a planar surface of the active portion 484. For example, the active portion 484 can comprise a unimorph piezoelectric material and the backplate 488 can be configured to bend in response to expansion and contraction of the unimorph piezoelectric material. The at least one coupler 450 can comprise further comprise a peripheral resilient portion (e.g., first spring portion 458) attached to the at least one mass 440 and a central resilient portion (e.g., second spring portion 459) attached to the coupling portion 420, with the backplate 488 between the central resilient portion and the peripheral resilient portion.

As schematically illustrated in FIGS. 9D and 9E, in certain implementations, the at least one coupler 450 comprises a substantially planar and rigid portion 457 above the peripheral portion 434 and a substantially planar and rigid portion 490 below the peripheral portion 434. The resilient material 454 is between the peripheral portion 434 and the rigid portions 457, 490 (e.g., a first portion 454a of the resilient material 454 is sandwiched between the rigid portion 457 and the peripheral portion 434 and a second portion 454b of the resilient material 454 is sandwiched between the rigid portion 490 and the peripheral portion 434). The resilient material 454 can also surround the outer perimeter 464 of the piezoelectric oscillator 430, as shown in FIGS. 9D and 9E. In certain implementations, the rigid portions 457, 490 are parts of a unitary component, as schematically illustrated by FIG. 9D, while in certain other implementations, the rigid portions 457, 490 are parts of separate components that fit together, as schematically illustrated by FIG. 9E.

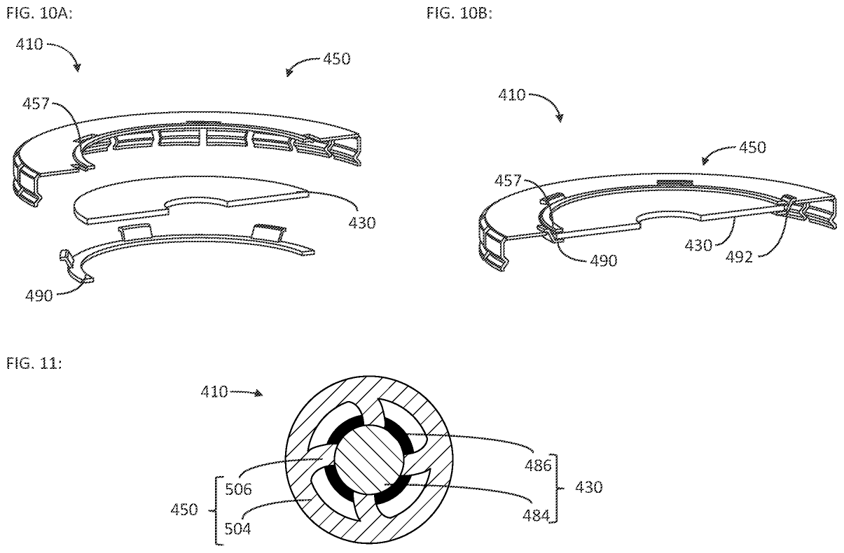

In certain implementations, the rigid portion 457, the rigid portion 490, and/or the coupling between the rigid portions 457, 490 can be sufficiently resilient such that the expansion and contraction of the piezoelectric oscillator 430 is not substantially inhibited. For example, FIGS. 10A and 10B schematically illustrate exploded and assembled cross-sectional views, respectively, of an example piezoelectric oscillator 430 and at least one coupler 450 in accordance with certain implementations described herein. The peripheral portion 434 of the piezoelectric oscillator 430 of FIGS. 10A and 10B is sandwiched between a first element (e.g., comprising the rigid portion 457) and a second element (e.g., comprising the rigid portion 490). In certain implementations, the at least one coupler 450 comprises a resilient material 454 sandwiched between the piezoelectric oscillator 430 and the rigid portions 457, 490 (e.g., as shown in FIGS. 9D and 9E). In certain other implementations, as schematically illustrated in FIGS. 10A and 10B, the rigid portions 457, 490 directly contact the piezoelectric oscillator 430 without a resilient material 454 sandwiched between the piezoelectric oscillator 430 and the rigid portions 457, 490. In certain implementations, the rigid portions 457, 490 define a gap 492 configured to allow expansion and contraction of the piezoelectric oscillator 430.

As schematically illustrated in FIGS. 9F and 9G, in certain implementations, the at least one coupler 450 comprises a first spring portion 458 attached to the at least one mass 440 and a second spring portion 476 attached to the peripheral portion 434 of the piezoelectric oscillator 430. In certain implementations, as schematically illustrated by FIG. 9F, the at least one coupler 450 further comprises a flexible material 477 (e.g., silicone) between the second spring portion 476 and the peripheral portion 434 (e.g., configured to affix the second spring portion 476 to the peripheral portion 434). In certain other implementations, as schematically illustrated by FIG. 9G, the at least one coupler 450 further comprises a flexible material 478 (e.g., silicone) between the second spring portion 476 and the at least one mass 440. The flexible material 477, 478 can be configured to provide vibration damping to tailor the vibrational frequency distribution of the actuator 410. In certain implementations, as schematically illustrated by FIG. 9G, the at least one coupler 450 comprises an angled portion 479 affixed to the peripheral portion 434 (e.g., by epoxy), the angled portion 479 configured to inhibit (e.g., avoid) a concentration of mechanical stress applied to the piezoelectric oscillator 430 by the at least one coupler 450.

As schematically illustrated in FIGS. 9H and 9I, in certain implementations, the at least one coupler 450 is affixed to the piezoelectric oscillator 430. For example, the at least one coupler 450 can comprise an extender portion 502 that is affixed (e.g., via epoxy 503) to the peripheral portion 434 of the piezoelectric oscillator 430. The extender portion 502 can be substantially parallel to the piezoelectric oscillator 430 as schematically illustrated by FIG. 9H or can be at a non-zero angle relative to the piezoelectric oscillator 430 as schematically illustrated by FIG. 9I. FIG. 11 schematically illustrates a top view of an example actuator 410 having the at least one coupler 450 affixed to the piezoelectric oscillator 430 in accordance with certain implementations described herein. The piezoelectric oscillator 430 comprises an active portion 484 (e.g., a substantially circular disk of piezoelectric material) and a passive portion 486 (e.g., a substantially circular ring of non-piezoelectric material) (see, e.g., FIG. 9B). The at least one coupler 450 can comprise a substantially circular ring 504 (e.g., comprising a rigid material) that is concentric with and extending around the piezoelectric oscillator 430 and configured to be attached to the at least one mass 440. The at least one coupler 450 can further comprise a plurality of spring arms 506 (e.g., extender portions 502) that extend from the ring 494 and are affixed to the passive portion 486.

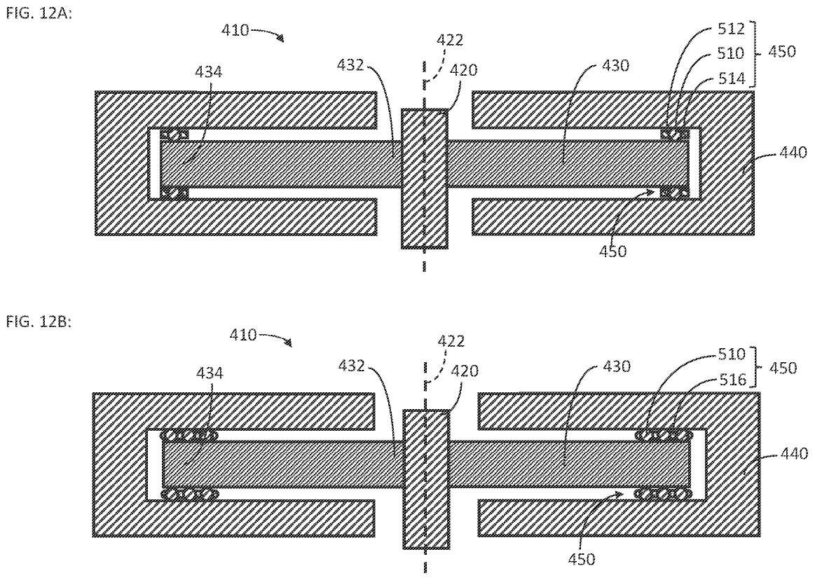

FIGS. 12A and 12B schematically illustrate cross-sectional views of two example actuators 410 with at least one coupler 450 in accordance with certain implementations described herein. The at least one coupler 450 of FIGS. 12A and 12B comprises a plurality of rigid elements 510 (e.g., balls; beads) in contact with the at least one mass 440 and in contact with the peripheral portion 434 of the piezoelectric oscillator 430. The rigid elements 510 of FIG. 12A are bounded by an inner rigid structure 512 (e.g., race) and an outer rigid structure 514 (e.g., race) configured to allow the rigid elements 510 to rotate while keeping the rigid elements 510 in position during the bending oscillations in which the piezoelectric oscillator 430 undergoes expansion and contraction. The rigid elements 510 of FIG. 12B are bounded by a binding material 516 (e.g., silicone; gel; glue) configured to hold the rigid elements 510 and to keep the rigid elements 510 in position during the bending oscillations in which the piezoelectric oscillator 430 undergoes expansion and contraction. In both FIGS. 12A and 12B, the rigid elements 510 are configured to allow the expansion and contraction of the peripheral portion 434 along the radial direction while inhibiting movement of the peripheral portion 434 relative to the at least one mass 440 in a direction perpendicular to the radial direction. For example, the rigid elements 510 can have only a small surface area in contact with the piezoelectric oscillator 430 such that the piezoelectric oscillator 430 can slide along the at least one coupler 450 during the bending oscillations.

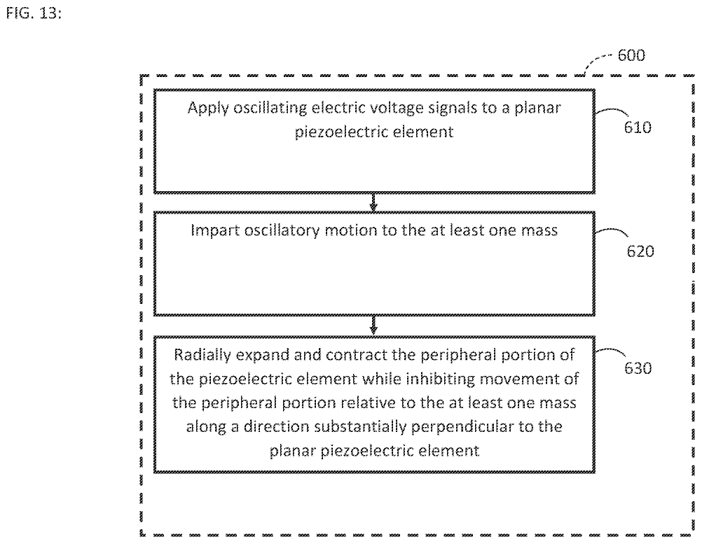

FIG. 13 is a flow diagram of an example method 600 in accordance with certain implementations described herein. In an operational block 610, the method 600 comprises applying oscillating electric voltage signals to a planar piezoelectric element (e.g., piezoelectric oscillator 430) having a central portion 432 in mechanical communication with a fixture implanted on or within a recipient's body and a peripheral portion 434 affixed to at least one mass 440 and spaced from the central portion 432. The piezoelectric element is responsive to the electric voltage signals by oscillating between a first configuration with at least a portion of the peripheral portion 434 extending above at least a portion of the central portion 432 (see, e.g., FIG. 4A) and a second configuration with at least a portion of the peripheral portion 434 extending below at least a portion of the central portion 432 (see, e.g., FIG. 4B).

In an operational block 620, the method 600 further comprises imparting oscillatory motion to the at least one mass 440, said oscillatory motion substantially perpendicular to the planar piezoelectric element. In an operational block 630, the method 600 further comprises radially expanding and contracting the peripheral portion 434 while inhibiting movement of the peripheral portion 434 relative to the at least one mass 440 along a direction substantially perpendicular to the planar piezoelectric element. In certain implementations, said positioning is performed prior to the first device being implanted on or within the recipient's body. In certain implementations, during operation of the first device and the second device, the unitary mass mitigates the formation of eddy currents within the unitary mass caused by the magnetic flux which can adversely affect the efficiency of the magnetic induction link.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of conventional cochlear implants, various implementations described herein can be incorporated in a variety of other suitable devices, methods, and contexts. More generally, as can be appreciated, certain implementations described herein can be used in a variety of implantable medical device contexts that can benefit from having at least a portion of the received power available for use by the implanted device during time periods in which the at least one power storage device of the implanted device unable to provide electrical power for operation of the implantable medical device.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another (e.g., one signal from another or one circuit from one another), and the ordinal adjective is not used to denote an order of these elements or of their use.

The invention described and claimed herein is not to be limited in scope by the specific example implementations herein disclosed, since these implementations are intended as illustrations, and not limitations, of several aspects of the invention. Any equivalent implementations are intended to be within the scope of this invention. Indeed, various modifications of the invention in form and detail, in addition to those shown and described herein, will become apparent to those skilled in the art from the foregoing description. Such modifications are also intended to fall within the scope of the claims. The breadth and scope of the invention should not be limited by any of the example implementations disclosed herein, but should be defined only in accordance with the claims and their equivalents.

1. An apparatus comprising:
an actuator configured to generate vibrations, the actuator comprising:
a coupling portion configured to be in operative communication with a fixture implanted on or within a recipient's body;
a substantially planar piezoelectric oscillator having a central portion substantially surrounding and in mechanical communication with the coupling portion and a peripheral portion spaced from the coupling portion, the piezoelectric oscillator configured to undergo bending oscillations in response to received electric voltage signals;
at least one mass in mechanical communication with the peripheral portion, the at least one mass configured to move in response to the bending oscillations of the piezoelectric oscillator; and
at least one coupler mechanically attached at least to the peripheral portion and the at least one mass, the at least one coupler configured to allow expansion and contraction of the peripheral portion along a first direction substantially parallel to the piezoelectric oscillator and to inhibit movement of the peripheral portion relative to the at least one mass along a second direction substantially perpendicular to the piezoelectric oscillator.

2. The apparatus of claim 1, wherein the at least one coupler comprises a substantially planar and bendable portion affixed to the piezoelectric oscillator and a first spring portion affixed to the at least one mass.

3. The apparatus of claim 2, wherein the at least one coupler further comprises a second spring portion affixed to the coupling portion.

4. The apparatus of claim 1, wherein the coupling portion extends from the fixture along a longitudinal axis, the piezoelectric oscillator extends along a plane substantially perpendicular to the longitudinal axis, the central portion comprises an inner perimeter of a hole extending through the piezoelectric oscillator through which the coupling portion extends, and the peripheral portion comprises an outer perimeter of the piezoelectric oscillator.

5. The apparatus of claim 4, wherein the at least one coupler comprises a flexible material and a rigid portion, a first portion of the flexible material sandwiched between the rigid portion and the peripheral portion of the piezoelectric oscillator, a second portion of the flexible material sandwiched between the at least one mass and the peripheral portion of the piezoelectric oscillator.

6. The apparatus of claim 4, wherein the at least one mass comprises an inner perimeter with a groove substantially surrounding the outer perimeter of the piezoelectric oscillator, the at least one coupler comprising a rigid material substantially surrounding the outer perimeter of the piezoelectric oscillator, the rigid material engaged by the groove, the at least one coupler further comprising a flexible material between the peripheral portion of the piezoelectric oscillator and the rigid material.

7. The apparatus of claim 5, wherein the at least one coupler comprises a plurality of rigid elements in contact with the at least one mass and in contact with the piezoelectric oscillator, the plurality of rigid elements bound by the flexible material, the plurality of rigid elements configured to allow the expansion and contraction of the peripheral portion along the first direction while inhibiting movement of the peripheral portion relative to the at least one mass along the second direction.

8. The apparatus of claim 4, wherein the at least one coupler comprises a central resilient portion attached to the coupling portion and a peripheral resilient portion attached to the at least one mass, the piezoelectric oscillator in mechanical communication with a portion of the at least one coupler between the central resilient portion and the peripheral resilient portion.

9. The apparatus of claim 8, wherein the at least one coupler further comprises a resilient material contacting the peripheral portion of the piezoelectric oscillator.

10. The apparatus of claim 4, wherein the at least one coupler comprises a first spring portion attached to the at least one mass and a second spring portion attached to the peripheral portion of the piezoelectric oscillator.

11. The apparatus of claim 10, wherein the at least one coupler further comprises a flexible material between the second spring portion and the peripheral portion of the piezoelectric oscillator.

12. The apparatus of claim 10, wherein the first spring portion comprises a first element and a second element, the peripheral portion of the piezoelectric oscillator sandwiched between the first element and the second element.

13. The apparatus of claim 1, wherein the piezoelectric oscillator comprises a disk-shaped piezoelectric element affixed to the coupling portion and a rigid non-piezoelectric element affixed to the piezoelectric element at a first radial distance from the coupling portion and extending to a second radial distance from the coupling portion, the second radial distance larger than the first radial distance.

14. The apparatus of claim 1, wherein the actuator is configured to be implanted on or within the recipient's body, the fixture configured to transmit the vibrations to the recipient's body such that the vibrations evoke a hearing percept by the recipient.

15. The apparatus of claim 1, further comprising a housing configured to hermetically seal the at least one mass and the piezoelectric oscillator from an environment surrounding the actuator.

16. A method comprising:
applying oscillating electric voltage signals to a planar piezoelectric element having a central portion in mechanical communication with a fixture implanted on or within a recipient's body and a peripheral portion affixed to at least one mass and spaced from the central portion, the piezoelectric element responding to the electric voltage signals by oscillating between a first configuration with at least a portion of the peripheral portion extending above at least a portion of the central portion and a second configuration with at least a portion of the peripheral portion extending below at least a portion of the central portion;
imparting oscillatory motion to the at least one mass, said oscillatory motion substantially perpendicular to the planar piezoelectric element; and
radially expanding and contracting the peripheral portion while inhibiting movement of the peripheral portion relative to the at least one mass along a direction substantially perpendicular to the planar piezoelectric element.

17. The method of claim 16, wherein the planar piezoelectric element is disk-shaped.

18. An apparatus comprising:
a substantially circular and planar piezoelectric material configured to generate vibrational energy by changing shape in response to received time-varying electrical voltage signals, the piezoelectric material comprising:
a central portion affixed to a cylindrical element in operative communication with a fixture implanted on or within a recipient's body; and
a peripheral portion substantially surrounding the central portion;
at least one mass in mechanical communication with the peripheral portion, the at least one mass configured to move relative to the cylindrical element in response to shape changes of the piezoelectric material; and
at least one coupler mechanically affixed to the peripheral portion and to the at least one mass, the at least one coupler configured to allow radial relative movements between the peripheral portion and the at least one mass, the radial relative movements substantially parallel to the peripheral portion, the at least one coupler configured to inhibit non-radial relative movements between the peripheral portion and the at least one mass, the non-radial relative movements substantially perpendicular to the peripheral portion.

19. The apparatus of claim 18, wherein the piezoelectric material is configured to change between a convex shape and a concave shape in response to the received electrical voltage signals.

20. The apparatus of claim 18, wherein the radial relative movements between the peripheral portion and the at least one mass are due to expansion and contraction of the piezoelectric material.

21. The apparatus of claim 18, wherein the at least one coupler comprises at least one resilient element that is sufficiently flexible in a radial direction and sufficiently rigid in a direction perpendicular to the radial direction such that flexing of the piezoelectric material vibrates the at least one mass.
